(19) United States
(12) Patent Application Publication
(10) Pub. No.: US 2025/0375334 A1
(43) Pub. Date: Dec. 11, 2025

(54) MEDICAL POSITIONERS WITH TOP LAYERS THAT MOVE IN A FLUID-LIKE MANNER

(71) Applicant: Greenwood Marketing, LLC, Bedford, NY (US)

(72) Inventors: William J. Purdy, Bedford, NY (US); Robert Purdy, Bedford, NY (US)

(21) Appl. No.: 19/235,509

(22) Filed: Jun. 11, 2025

Related U.S. Application Data
(60) Provisional application No. 63/658,534, filed on Jun. 11, 2024.

(51) Int. Cl. A61G 11/00

(52) U.S. Cl. CPC A61G 11/00

(57) ABSTRACT

A positioner includes a bottom layer, an intermediate element, and a top layer. The top layer can move laterally over the bottom layer, while the intermediate element limits the extent to which the top layer can move over the bottom layer. The top layer, the bottom layer, and the ability of the top layer to move across the bottom layer may impart the positioner with characteristics that mimic a human uterus, enabling the positioner to be used to support premature infants. Methods of using the positioner are also disclosed.

### CROSS-REFERENCE TO RELATED APPLICATION

A claim is hereby made to the Jun. 11, 2024 filing date of U.S. Provisional Patent Application No. 63/658,534, titled MEDICAL POSITIONERS WITH TOP LAYERS THAT MOVE IN A FLUID-LIKE MANNER (“the '534 Provisional Application”). The entire disclosure of the '534 Provisional Application is hereby incorporated herein.

### TECHNICAL FIELD

This disclosure relates generally to positioners and, more, specifically, to positioners for premature infants. A positioner of this disclosure mimics an in utero environment. Methods of manufacturing and using such a positioner are also disclosed.

### RELATED ART

Positioners are used by medical professionals to position individuals and parts of individuals' bodies. Typically, a positioner is placed beneath the individual or part of the individual's body to hold the body or body part in a particular orientation. For example, a positioner may be placed in a crib for a premature infant to orient the infant, including their head and/or body.

While most positioners from premature infants may be used to support the infants in desired orientations, they do not provide any additional benefit to the infant. However, Greenwood Marketing, LLC d/b/a/Spry Therapeutics has developed moldable positioners, including a neonatal intensive care unit (NICU) positioner, with flexible membranes that hold a fluidized medium. Such a moldable positioner may be three-dimensionally shaped. A NICU positioner may be shaped to support infants who do not tolerate physical handling well in the infants' desired positions, enabling a caregiver to create, adjust, and maintain environments that provide consistent therapeutic positioning for the infants while mimicking the shape of the infants' mothers' wombs.

### SUMMARY

A positioner of this disclosure may include a base chamber and an outer chamber. The outer chamber may move laterally relative to the base chamber. Lateral movement of the outer chamber relative to the base chamber may be in two directions; for example, movement of the outer chamber relative to the base chamber may have an x component and a y component. The outer chamber may be tethered to the base chamber. The base chamber and outer chamber may be filled with materials that enable the positioner to mimic conditions within the uterus, or in utero. Thus, the positioner may mimic a mother's womb.

In a specific embodiment, a positioner of this disclosure may include a base chamber, an intermediate chamber, and an outer chamber. The base chamber, intermediate chamber, and outer chamber may be filled with materials that enable the positioner to mimic conditions within the uterus, or a mother's womb. For example, the outer chamber may resemble amniotic fluid and/or an inner layer of the uterus (e.g., the endometrium, or inner lining, of the uterus), while the base chamber may resemble a middle layer of the uterus (e.g., the myometrium, or muscle layer, of the uterus) and/or an outer layer of the uterus (e.g., the serosa, or protective outer layer, of the uterus). In addition, the intermediate chamber may enable the outer chamber to move laterally relative to the base chamber, as may occur when a shear force applied to amniotic fluid against an inner surface of a uterus and/or the inner layer of the uterus causes the amniotic fluid and/or inner layer of the uterus to slide relative to the middle layer and/or outer layer of the uterus.

The base chamber, intermediate chamber, and outer chamber may share a common periphery. Thus, the outer boundaries of all three chambers and the layers they are part of may be coextensive. The base chamber, intermediate chamber, and outer chamber may be formed from a pliable material that may be sealed and is impermeable to liquids. Without limitation, the base chamber, intermediate chamber, outer chamber, and their peripheral walls may be formed from a film defined from a polymer (e.g., polyurethane, etc.).

The base chamber and its fill may mimic a wall of a female human uterus (i.e., a uterine wall; e.g., the myometrium and/or serosa of the uterus). As a non-limiting example, the fill of the base chamber may include acrylic microspheres and a quantity of a suitable lubricant, such as a silicone (e.g., a liquid silicone, or a silicone oil; a silicone gel;

etc.). The acrylic microspheres may be suspended in and dispersed throughout the silicone. The ratio of lubricant to acrylic microspheres may result in a pliable, but somewhat stiff mixture, imparting the base chamber with a stiffness comparable to a stiffness of the uterine wall. As another non-limiting example, the base chamber may be filled with compressible beads, such as polyethylene beads. Together, the base chamber and its fill may form a bottom layer of the positioner.

The fill of the intermediate chamber may comprise a lubricant that will enable the base chamber and the outer chamber to slide relative to one another. The lubricant may only partially fill the intermediate chamber. In some embodiments, the lubricant may fill only a small portion of the intermediate chamber (e.g., less than 10% of a volume of the intermediate chamber, less than 5% of the volume of the intermediate chamber, less than 2% of the volume of the intermediate chamber, less than 1% of the volume of the intermediate chamber, enough to coat all of the inner surfaces of the intermediate chamber, enough to coat some of the inner surfaces of the intermediate chamber, etc.). Limiting the amount of lubricant within the intermediate chamber may enable peripheral walls of the intermediate chamber to bulge laterally outward in a manner that may maximize the lateral extent to which the outer chamber may slide relative to the base chamber, with that lateral extent being primarily limited by the heights of the peripheral walls of the intermediate chamber. The lubricant may reduce, or break, a coefficient of friction between the inner surfaces of the top and bottom of the intermediate chamber and, thus, a coefficient of friction between the base chamber and the outer chamber. Some non-limiting examples of lubricants include silicone, mineral oil, microspheres, lubricated microspheres, graphene, graphite, and the like. Together, the intermediate chamber and its fill may define a middle layer of the positioner.

The outer chamber and its fill may mimic amniotic fluid within the female human uterus and/or the inner surface of the female human uterus (e.g., the inner layer, or endometrium, of the uterus). The fill of the outer chamber may be looser or wetter and, thus, softer and more pliable than the fill of the base chamber. As a non-limiting example, the fill of the outer chamber may include acrylic microspheres and a quantity of a suitable lubricant, such as a silicone (e.g., a liquid silicone, or a silicone oil; a silicone gel; etc.). The acrylic microspheres may be suspended in and dispersed throughout the silicone. The ratio of lubricant to acrylic microspheres may be higher than the ratio of lubricant to acrylic microspheres of the fill of the base chamber, imparting the outer chamber with a conformability comparable to a viscosity or a conformability of a fluid in contact with a fetus in an amniotic sac. Without limitation, the fill within the outer chamber may include up to about 40% more oil, by weight, than a comparable volume of the fill within the base chamber. Together, the outer chamber and its fill may form a top layer of the positioner.

In another specific embodiment, a positioner of this disclosure may include a base chamber and an outer chamber. The base chamber and outer chamber may be filled with materials that enable the positioner to mimic conditions within the uterus. For example, the outer chamber may resemble the amniotic fluid within a uterus and/or the inner layer of the uterus, while the base chamber may resemble a middle layer of the uterus and/or an outer layer of the uterus. In addition, the outer chamber may be able to move laterally relative to the base chamber, as may occur when a shear force applied to the amniotic fluid and/or the inner surface of a uterus causes the amniotic fluid and/or inner layer of the uterus to slide relative to the middle layer and/or outer layer of the uterus.

The base chamber and outer chamber may be formed from a pliable material that may be sealed and is impermeable to liquids. Without limitation, the base chamber and outer chamber may be formed from a film defined from a polymer (e.g., polyurethane, etc.).

The base chamber and its fill may mimic a wall of a female human uterus (i.e., a uterine wall; e.g., the myometrium and/or serosa of the uterus). As a non-limiting example, the fill of the base chamber may include acrylic microspheres and a quantity of a suitable lubricant, such as a silicone (e.g., a liquid silicone, or a silicone oil; a silicone gel; etc.). The acrylic microspheres may be suspended in and dispersed throughout the silicone. The ratio of lubricant to acrylic microspheres may result in a pliable, but somewhat stiff mixture, imparting the base chamber with a stiffness comparable to a stiffness of the uterine wall. As another non-limiting example, the base chamber may be filled with compressible beads, such as polyethylene beads. Together, the base chamber and its fill may form a bottom layer of the positioner.

An upper surface of the base chamber may be coated with a material that enables the upper chamber to slide laterally over the base chamber. For example, the top surface of the base chamber may be coated with polytetrafluoroethylene (PTFE).

The positioner may include one or more tethers that secures the base chamber and upper chamber to one another while allowing the upper chamber to move laterally relative to the base chamber. A length of each tether may dictate the extent to which the upper chamber may move over the base chamber. Each tether may be continuous with or be secured to a periphery and/or the upper surface of the base chamber. Each tether may comprise a film formed from a polymer (e.g., polyurethane, etc.).

The outer chamber and its fill may mimic the amniotic fluid within the female human uterus and/or the inner surface of the female human uterus (e.g., the inner layer, or endometrium, of the uterus). The fill of the outer chamber may be looser or wetter and, thus, softer and more pliable than the fill of the base chamber. As a non-limiting example, the fill of the outer chamber may include acrylic microspheres and a quantity of a suitable lubricant, such as a silicone (e.g., a liquid silicone, or a silicone oil; a silicone gel; etc.). The acrylic microspheres may be suspended in and dispersed throughout the silicone. The ratio of lubricant to acrylic microspheres may be higher than the ratio of lubricant to acrylic microspheres of the fill of the base chamber, imparting the outer chamber with a conformability comparable to a viscosity or a conformability of a fluid in contact with a fetus in an amniotic sac. Without limitation, the fill within the outer chamber may include up to about 40% more oil, by weight, than a comparable volume of the fill within the base chamber. Together, the outer chamber and its fill may form a top layer of the positioner.

A lower surface of the upper chamber may be coated with a material that enables the upper chamber to slide laterally over the base chamber. For example, the lower surface of the upper chamber may be coated with polytetrafluoroethylene (PTFE).

In embodiments where the positioner is to be used with a premature infant, the bottom layer of the positioner may be placed against a surface that is to support the infant (e.g., a support surface of a crib, etc.). The bottom layer may be deformed, or molded, to form outer walls that define a depression, or a bowl. The infant may then be positioned against or on the outer layer of the positioner. The infant may sink into, or be partially immersed in, the top layer when the infant is positioned on the positioner. The depression in the bottom layer may support the infant, with its peripheral wall preventing the infant from sliding off the positioner, and functionally resemble the uterine wall.

The top layer of the positioner may move relative to the bottom layer of the positioner. In embodiments where the positioner includes a middle layer, the middle layer of the positioner and, more specifically, the lubricant of the middle layer may enable the top layer to move relative to the bottom layer with any micro movement of the infant. Thus, the middle layer of the positioner may reduce or eliminate any friction between the infant and the top layer of the positioner, allow the top layer to slide and roll like a true fluid until the infant outgrows the positioner (similar to the manner in which a infant can move within the uterus until the infant outgrows the uterus), and/or prevent the top from bottoming out, and/or prevent the infant from sliding off of the top layer of the positioner (since the peripheral walls of the intermediate chamber limit the extent that the top layer can move laterally relative to the bottom layer).

In embodiments where the positioner lacks a middle layer, the top layer may slide over the bottom layer. A friction-reducing layer on one or both of the top layer and middle layer may enable the top layer to readily slide over the bottom layer. One or more tethers between the top layer and the bottom layer may limit the extent to which the top layer may slide relative to the bottom layer.

The configuration of the positioner enables the layers to perform their functions separately since they don't share material. The resulting structure may provide attenuated conformational positioning for a subject, such as a premature infant. When the subject is a premature infant, a configuration of the positioner may enable the premature infant who rests against or on the outer chamber of the positioner to develop a proprioceptive response (i.e., knowing where they are in space as their eyes are closed) as they move against or on the positioner.

Other aspects of the disclosed subject matter, as well as features and advantages of various aspects of the disclosed subject matter, should be apparent to those of ordinary skill in the art through consideration of the preceding disclosure, the accompanying drawings, the ensuing description, and the appended claims.

### BRIEF DESCRIPTION OF THE DRAWINGS

In the drawings:

FIG. 1 is a cross-sectional representation of an embodiment of a positioner of this disclosure;

FIG. 2 is a cross-sectional representation of the embodiment of the positioner shown in FIG. 1, with a top layer of the positioner being laterally offset from a bottom layer of the positioner;

FIG. 3 is a cross-sectional representation of another embodiment of a positioner of this disclosure; and

FIG. 4 is a cross-sectional representation of the embodiment of the positioner shown in FIG. 3, with a top layer of the positioner being laterally offset from a bottom layer of the positioner.

### DETAILED DESCRIPTION

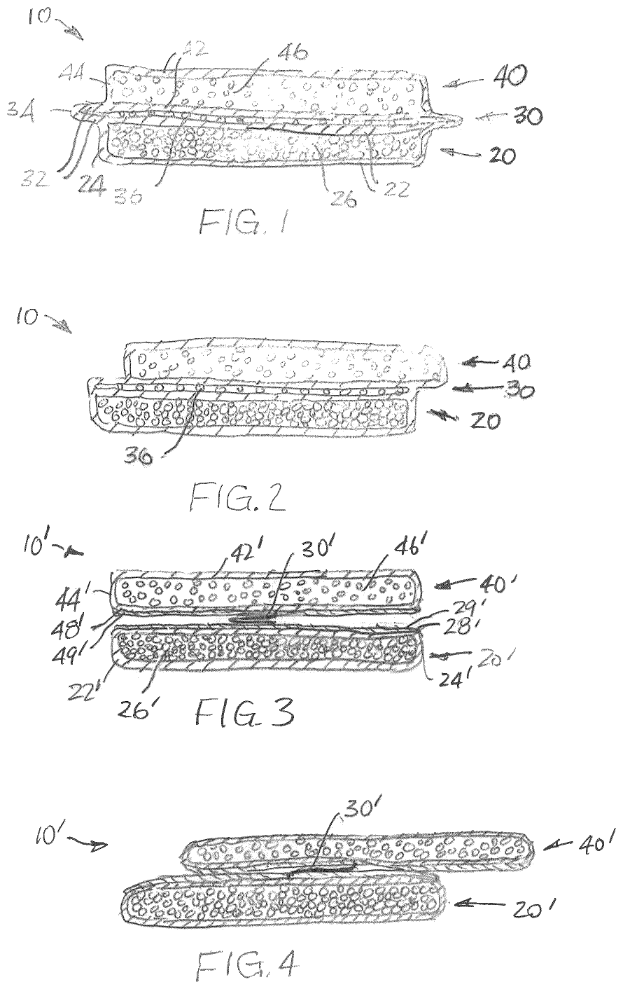

With reference 1 FIG. 1, an embodiment of a positioner 10 is depicted. The positioner 10 includes a bottom layer 20, a middle layer 30, and a top layer 40.

The bottom layer 20 of the positioner 10 includes a base chamber 22 defined from a pliable material. For example, the base chamber 22 may be defined from a film. The film may comprise a polymeric film. Polyurethane is a nonlimiting example of a polymeric film that may be used to define the base chamber 22. The base chamber 22 includes peripheral walls 24, which define a lateral extent of the base chamber 22.

An interior of the base chamber 22 is at least partially filled with a fill material 26. Together, the base chamber 22 and the fill material 26 therein are deformable and enable the bottom layer 20 to be molded to a desired shape (e.g., a bowl shape, etc.). The fill material 26 may include acrylic microspheres and a quantity of a suitable lubricant, such as a silicone (e.g., a liquid silicone, or a silicone oil; a silicone gel; etc.). The acrylic microspheres may be suspended in and dispersed throughout the silicone. The ratio of lubricant to acrylic microspheres may result in a pliable, but somewhat stiff mixture, imparting the bottom layer 20 with a stiffness comparable to a stiffness of the myometrium and/or serosa of the uterine wall. As another non-limiting example, the fill material 26 may comprise compressible beads, such as polyethylene beads. The polyurethane beads may have a size (or sizes) and a stiffness that may impart the bottom layer 20 of the positioner 10 with a stiffness comparable to a stiffness of the myometrium and/or serosa of the uterine wall.

The middle layer 30 of the positioner 10 includes an intermediate chamber 32 defined from a pliable material. For example, the intermediate chamber 32 may be defined from a film. The film may comprise a polymeric film, such as a polyurethane film. The intermediate chamber 32 includes peripheral walls 34 that may be coextensive with (e.g., shared with, etc.) the peripheral walls 24 of the base chamber 22.

An interior of the intermediate chamber 32 may carry a fill material 36 that comprises a lubricant. A volume of the fill material 36 may only partially fill the interior of the intermediate chamber 32, enabling the peripheral walls 34 of the intermediate chamber 32 to bulge outwardly, as shown, or fold in upon themselves.

The fill material 36 may comprise a lubricant that will enable the base chamber 22 and an outer chamber 42 of the top layer 40 of the positioner 10 to slide relative to one another. The lubricant 36 may only partially fill the intermediate chamber 32. In some embodiments, the lubricant 36 may fill only a small portion of the intermediate chamber 32 (e.g., less than 10% of a volume of the intermediate chamber 32, less than 5% of the volume of the intermediate chamber 32, less than 2% of the volume of the intermediate chamber 32, less than 1% of the volume of the intermediate chamber 32, enough to coat all of the inner surfaces of the intermediate chamber 32, enough to coat some of the inner surfaces of the intermediate chamber 32, etc.). Limiting the amount of lubricant 36 within the intermediate chamber 32 may enable peripheral walls 34 of the intermediate chamber 32 to bulge laterally outward in a manner that may maximize the lateral extent to which the outer chamber 22 may slide relative to the base chamber 42, with that lateral extent being primarily limited by the heights of the peripheral walls 34 of the intermediate chamber 32. The lubricant 36 may reduce, or break, a coefficient of friction between the inner surfaces of the top and bottom of the intermediate chamber 32 and, thus, a coefficient of friction between the base chamber 22 and the outer chamber 42. Some non-limiting examples of lubricants 36 include silicone, mineral oil, microspheres, lubricated microspheres, graphene, graphite, and the like.

The top layer 40 of the positioner 10 includes an upper chamber 42 defined from a pliable material. For example, the upper chamber 42 may be defined from a film. The film may comprise a polymeric film, such as a polyurethane film. The upper chamber 42 includes peripheral walls 44 that may be coextensive with the peripheral walls 34 of the intermediate chamber 32 and/or the peripheral walls 24 of the base chamber 22.

A fill material 46 within an interior of the upper chamber 42 may be looser and/or wetter than the fill material 26 within the base chamber 22. Together, the upper chamber 42 and the fill material 46 therein may resemble a fluid (e.g., amniotic fluid, etc.), within which a subject (e.g., a premature infant, etc.) may be immersed. As a non-limiting example, the fill material 46 may include acrylic microspheres and a quantity of a suitable lubricant, such as a silicone (e.g., a liquid silicone, or a silicone oil; a silicone gel; etc.). The acrylic microspheres may be suspended in and dispersed throughout the silicone. The ratio of lubricant to acrylic microspheres may be higher than the ratio of lubricant to acrylic microspheres of the fill of the base chamber, imparting the outer chamber with a conformability comparable to a viscosity or a conformability of a fluid in contact with a fetus in an amniotic sac. Without limitation, the fill material 46 within the outer chamber 42 may include up to about 40% more oil, by weight, than a comparable volume of the fill material 26 within the base chamber 22.

Altogether, the positioner 10 includes four substantially parallel layers of pliable material (e.g., polyurethane films, etc.) with common peripheral walls.

As shown in FIG. 2, a configuration of the middle layer 30, including the fill material 36 of the middle layer 30, enables the top layer 40 to move laterally relative to the bottom layer 20. While FIG. 2 shows such lateral movement in a single direction, movement in any lateral direction or a combination of lateral directions over a plane in which the middle layer 30 resides is possible.

Referring now to FIG. 3, another embodiment of a positioner 10′ is depicted. The positioner 10′ includes a bottom layer 20′ and a top layer 40′. The positioner 10′ also includes at least one tether 30′.

The bottom layer 20′ of the positioner 10′ includes a base chamber 22′ defined from a pliable material. For example, the base chamber 22′ may be defined from a film. The film may comprise a polymeric film. Polyurethane is a nonlimiting example of a polymeric film that may be used to define the base chamber 22′. The base chamber 22′ includes peripheral walls 24′, which define a lateral extent of the base chamber 22′.

An interior of the base chamber 22′ is at least partially filled with a fill material 26′. Together, the base chamber 22′ and the fill material 26′ therein are deformable and enable the bottom layer 20′ to be molded to a desired shape (e.g., a bowl shape, etc.). The fill material 26′ may include acrylic microspheres and a quantity of a suitable lubricant, such as a silicone (e.g., a liquid silicone, or a silicone oil; a silicone gel; etc.). The acrylic microspheres may be suspended in and dispersed throughout the silicone. The ratio of lubricant to acrylic microspheres may result in a pliable, but somewhat stiff mixture, imparting the bottom layer 20′ with a stiffness comparable to a stiffness of the myometrium and/or serosa of the uterine wall. As another non-limiting example, the fill material 26′ may comprise compressible beads, such as polyethylene beads. The polyurethane beads may have a size (or sizes) and a stiffness that may impart the bottom layer 20′ of the positioner 10′ with a stiffness comparable to a stiffness of the myometrium and/or serosa of the uterine wall.

A top surface 28′ of the base chamber 22′ may optionally be coated with a friction-reducing layer 29′. The friction-reducing layer 29′ may comprise a material that enables an upper chamber 42′ of the top layer 40′ to slide laterally over the base chamber 22′. For example, the friction-reducing layer 29′ may comprise polytetrafluoroethylene (PTFE).

Each tether 30′ of the positioner 10′ extends from an upper portion (e.g., edge, surface, etc.) of the base chamber 22′. Each tether 30′ may be continuous with a portion of the base chamber 22′. Alternatively, each tether 30′ may be secured to the base chamber 22′ (e.g., with a suitable adhesive material, by an ultrasonic weld, by a thermal weld, etc.). Each tether 30′ may be flexible or pliable. In some embodiments, each tether 30′ may comprise a film or strand. Such a film or strand may be formed from a polymeric material, such as a polyurethane.

The top layer 40′ of the positioner 10′ includes an upper chamber 42′ defined from a pliable material. For example, the upper chamber 42′ may be defined from a film. The film may comprise a polymeric film, such as a polyurethane film. The upper chamber 42′ includes peripheral walls 44′, which define a lateral extent of the upper chamber 42′.

A bottom surface 48′ of the upper chamber 42′ faces and contacts the top surface 28′ of the base chamber 22′. The bottom surface 48′ of the upper chamber 42′ can slide across the top surface 28′ of the base chamber 22′. The bottom surface 48′ may optionally be coated with a friction-reducing layer 49′. The friction-reducing layer 49′ may comprise a material that enables an upper chamber 42′ of the top layer 40′ to slide laterally over the base chamber 22′. For example, the friction-reducing layer 49′ may comprise polytetrafluoroethylene (PTFE).

Each tether 30′ extends to a lower portion (e.g., edge, surface, etc.) of the upper chamber 42′. Each tether 30′ may be continuous with a portion of the upper chamber 42′. Alternatively, each tether 30′ may be secured to the upper chamber 42′ (e.g., with a suitable adhesive material, by an ultrasonic weld, by a thermal weld, etc.).

A fill material 46′ within an interior of the upper chamber 42′ may be looser and/or wetter than the fill material 26′ within the base chamber 22′. Together, the upper chamber 42′ and the fill material 46′ therein may resemble a fluid (e.g., amniotic fluid, etc.), within which a subject (e.g., a premature infant, etc.) may be immersed. As a non-limiting example, the fill material 46′ may include acrylic microspheres and a quantity of a suitable lubricant, such as a silicone (e.g., a liquid silicone, or a silicone oil; a silicone gel; etc.). The acrylic microspheres may be suspended in and dispersed throughout the silicone. The ratio of lubricant to acrylic microspheres may be higher than the ratio of lubricant to acrylic microspheres of the fill of the base chamber, imparting the outer chamber with a conformability comparable to a viscosity or a conformability of a fluid in contact with a fetus in an amniotic sac. Without limitation, the fill material 46′ within the outer chamber 42′ may include up to about 40% more oil, by weight, than a comparable volume of the fill material 26′ within the base chamber 22′.

As shown in FIG. 4, a length of each tether 30′ enables the top layer 40′ to move laterally relative to the bottom layer 20′. While FIG. 4 shows such lateral movement in a single direction, movement in any lateral direction or a combination of lateral directions over a plane between the top layer 40′ and the bottom layer 20′ is possible.

Although the disclosure provides many specifics, the specifics should not be construed as limiting the scope of any of the claims, but merely as providing illustrations of some embodiments of elements and features of the disclosed subject matter that fall within the scopes of the claims. Other embodiments of the disclosed subject matter may be devised that are also within the scopes of the claims. Accordingly, the scope of each claim is limited only by its plain language and the legal equivalents thereto.

What is claimed:

1. A medical positioner, comprising:
a bottom layer including:
a base chamber comprising a first film, a second film, and peripheral walls; and
a fill material within the base chamber and imparting the bottom layer with a first deformability;
a middle layer over the bottom layer and including:
an intermediate chamber comprising the second film, a third film, and peripheral walls; and
a fill material occupying a portion of a maximum volume of the intermediate chamber and comprising a lubricant that reduces friction between the second film and the third film;
a top layer over the middle layer and including:
an upper chamber comprising the third film, a fourth film, and peripheral walls; and
a fill material within the upper chamber imparting the top layer with a second deformability.

2. The medical positioner of claim 1, wherein the peripheral walls of the base chamber, the intermediate chamber, and the upper chamber are coextensive.

3. The medical positioner of claim 1, wherein the peripheral walls of the intermediate chamber bulge and/or fold inwardly upon themselves.

4. The medical positioner of claim 3, herein the peripheral walls of the intermediate chamber define an extent to which the top layer may slide laterally relative to the bottom layer.

5. The medical positioner of claim 1, wherein the first film, the second film, the third film, the fourth film, and the peripheral walls comprise polyurethane.

6. The medical positioner of claim 1, wherein the first film, the second film, the third film, and the fourth film are substantially parallel to each other.

7. The medical positioner of claim 1, wherein the fill material of the top layer is looser than the fill material of the bottom layer.

8. The medical positioner of claim 7, wherein the first deformability of the bottom layer renders the first layer moldable.

9. The medical positioner of claim 8, wherein the second deformability of the top layer imparts the top layer with fluid-like behavior.

10. The medical positioner of claim 9, wherein the bottom layer mimics a uterine wall and the top layer mimics amniotic fluid.

11. A method for positioning a premature infant, comprising:
molding a bottom layer of a positioner to define a depression sized to receive the premature infant;
placing the premature infant on or against a top layer of the positioner, the premature infant being partially immersed in the top layer; and
enabling the top layer to move laterally relative to the bottom layer as the premature infant moves on the top layer.

12. The method of claim 11, wherein enabling the top layer to move laterally relative to the bottom layer comprises minimizing a coefficient of friction between the top layer and the bottom layer while limiting an extent to which the top layer may move laterally relative to the bottom layer.

13. The method of claim 11, wherein enabling the top layer to move laterally relative to the bottom layer comprises enabling the premature infant to develop a proprioceptive response.

14. The method of claim 11, wherein placing the premature infant on or against the top layer comprises placing the premature infant on a top layer that mimics amniotic flid within a mother's womb.

15. The method of claim 14, wherein placing the premature infant on or against the top layer further comprises placing the premature infant over a bottom layer that mimics a uterine wall.

16. A medical positioner, comprising:
a bottom layer including:
a base chamber; and
a fill material within the base chamber and imparting the bottom layer with a first deformability;
a top layer over the bottom layer and including:
an upper chamber; and
a fill material within the upper chamber imparting the top layer with a second deformability that differs from the first deformability; and
an intermediate element that secures the top layer to the bottom layer and enables the top layer to slide laterally over the bottom layer.

17. The medical positioner of claim 16, wherein the intermediate element comprises:
a middle layer between the bottom layer and the top layer, including:
an intermediate chamber; and
a lubricant within the intermediate chamber.

18. The medical positioner of claim 16, wherein the intermediate element comprises:
at least one tether joining a bottom portion of the top layer to an upper portion of the bottom layer.

19. The medical positioner of claim 18, further comprising:
a friction-reducing layer on at least one of a top surface of the lower chamber and a bottom surface of the top layer.

20. The medical positioner of claim 19, wherein the friction-reducing layer comprises polytetrafluoroethylene.
